(19) United States
(12) Patent Application Publication
(10) Pub. No.: US 2013/0196890 A1
(43) Pub. Date: Aug. 1, 2013

(54) STABLE, VISCOUS, PEROXIDE CONTAINING LAVATORY TREATMENT COMPOSITIONS

(71) Applicant: Reckitt Benckiser LLC, Parsippany, NJ (US)

(72) Inventor: Sarah Marie Post, Garnerville, NY (US)

(73) Assignee: RECKITT BENCKISER LLC, Parsippany, NJ (US)

(21) Appl. No.: 13/749,201

(22) Filed: Jan. 24, 2013

Related U.S. Application Data
(60) Provisional application No. 61/592,071, filed on Jan. 30, 2012.

(51) Int. Cl. C11D 3/48

(52) U.S. Cl. CPC C11D 3/48
USPC 510/363; 510/375; 510/109

(57) ABSTRACT

Provided is shelf stable, largely aqueous hard surface treatment composition which comprises at least water, at least one or more peroxygen compounds, and especially preferably wherein compositions comprise (or consist essentially of, or consist of): hydrogen peroxide, a betaine surfactant, an anionic surfactant, a water soluble or water dispersible metal salt, a chelating agent, an inorganic acid constituent, optionally a pH adjusting agent, and optionally one or more further constituents which provide a technical or aesthetic benefit to the inventive composition of which it forms a part. In preferred embodiments, the compositions are viscous, exhibiting a viscosity in the range of about 100-2000 cPs, preferably about 500-1200 cPs when measured at room temperature and exhibits a pH in the range of about 2 to about 4, preferably about 2.5-3.5. The treatment compositions are also characterized in that they contain no organic acids comprising less than three carboxylate (—COOH) moieties, and that the acid constituent is based on one or more inorganic acids, and preferably is a sulfonic acid.

The present invention relates to antimicrobially effective, hard surface treatment compositions which comprise a peroxygen compound, and more particularly relates to a shelf stable, viscous, hard surface treatment composition containing a comprise a peroxygen compound which is particularly suited for the treatment of lavatory surfaces, particularly toilets. Preferred embodiments of the hard surface treatment compositions provide both cleaning efficacy and are antimicrobially effective against one or more microorganisms with which they are contacted.

While the art is replete with hard surface cleaning compositions which are effective in the cleaning of a variety of stains which are frequently encountered in lavatories and bathrooms, e.g., limescale stains, soap scum stains and organic soils, the effective cleaning of lavatory appliances, e.g., toilets, requires that effective coverage of surfaces intended to be treated with the composition occur in order to ensure that contact between a cleaning composition and the stains present on the surface occur. Without such contact, ineffective cleaning is to be expected.

While many thickened compositions are known to the art, only a small proportion utilize a bleach constituent or hydrogen peroxide. Such compositions are difficult to produce as it is known to be difficult to formulate into a shelf stable product which can be packaged and vended, which packaged product maintains a good degree of the initial bleach or hydrogen peroxide and which demonstrates little or no deformation of the package following an extended period of storage, and/or storage at elevated temperatures for any period of time.

It is to these and further shortcomings in the art that the present invention is directed.

In a first aspect there is provided a largely aqueous hard surface treatment composition which comprises at least water, at least one or more peroxygen compounds, and especially preferably wherein compositions comprise (or consist essentially of, or consist of): hydrogen peroxide, a betaine surfactant, an anionic surfactant, a water soluble or water dispersible metal salt, a chelating agent, an inorganic acid constituent, optionally a pH adjusting agent, and optionally one or more further constituents which provide a technical or aesthetic benefit to the inventive composition of which it forms a part. In preferred embodiments, the compositions are viscous, exhibiting a viscosity in the range of about 100-2000 cPs, preferably about 500-1200 cPs when measured at room temperature and exhibits a pH in the range of about 2 to about 4, preferably about 2.5-3.5. The treatment compositions are also characterized in that they contain no organic acids comprising less than three carboxylate (—COOH) moieties, and that the inorganic acid constituent preferably is a sulfonic acid.

In a second aspect of the invention there is provided a diluted form of the composition of the first aspect of the invention, wherein compositions according to the first aspect are diluted with a further amount of water in ratios of composition:water of 1:2-25, and preferably 1:2-10. Such compositions according to this second aspect of the invention may exhibit reduced viscosities in the range of about 1-2000 cPs, and preferably about 1-500 cPs which makes them more readily pumpable from

In a third aspect of the invention there is provided a process for the cleaning treatment of hard surfaces, the process comprising the step of applying a cleaning effective amount of the aforesaid largely aqueous hard surface treating composition according to any prior aspect of the invention to a hard surface in need of a cleaning treatment.

According to a fourth aspect of the invention the there is provided a process for the cleaning treatment of hard surfaces, and in particular cleaning of one or more stains selected from rust stains, greasy soils, and limescale deposits or limescale stains, the process comprising the step of applying a cleaning effective amount of the aforesaid largely aqueous hard surface treating composition according to any prior aspect of the invention to a hard surface in need of a cleaning treatment.

According to a fifth aspect of the invention is provided a process for the remediation of eradication of undesired microorganisms which are present or suspected the present on hard surface, the process comprising the steps of applying an antimicrobially effective amount of a hard surface treatment composition according to any prior aspect of the invention, to the hard surface for a sufficient time in order to provide a desired antimicrobial effect.

According to a sixth aspect of the invention there is provided a method for the production of an improved largely aqueous hard surface treatment composition according to any prior aspect of the invention, or as otherwise described herein.

Further aspects of the invention will be more apparent from reading of the following specification.

In the treatment compositions of the instant invention, the peroxygen compound may be essentially any compound containing a dioxygen (O—O) bond. Dioxygen bonds, particularly bivalent O—O bonds, are readily cleavable, thereby allowing compounds containing them to act as powerful oxidizers. Non-limiting examples of classes of peroxygen compounds include peracids, peracid salts, and peroxides such as hydrogen peroxide. The peroxygen can be any aliphatic or aromatic peracid (or peroxyacid) that is functional for disinfectant purposes in accordance with embodiments of the present invention. While any functional peroxyacid can be used, peroxyacids containing from 1 to 7 carbons are the most practical for use. These peroxyacids can include, but not be limited to, peroxyformic acid, peroxyacetic acid, peroxyoxalic acid, peroxypropanoic acid, perlactic acid, peroxybutanoic acid, peroxypentanoic acid, peroxyhexanoic acid, peroxyadipic acid, peroxycitric, and/or peroxybenzoic acid. Exemplary peracid salts include permanganates, perborates, perchlorates, peracetates, percarbonates, persulphates, and the like. Exemplary peroxide compounds include hydrogen peroxide, metal peroxides and peroxyhydrates. The metal peroxides that can be used include, but are not limited to, sodium peroxide, magnesium peroxide, calcium peroxide, barium peroxide, and/or strontium peroxide. Other salts (for example sodium percarbonate) have hydrogen peroxide associated therewith are also considered to be a source of hydrogen peroxide, thereby producing hydrogen peroxide in situ.

Advantageously the peroxygen compound comprises up to about 5% wt., preferably up to about 3% wt., yet more preferably up to about 2% wt, still more preferably up to about 1.5% wt., of the largely aqueous hard surface treatment compositions taught herein. Advantageously also, the peroxygen compound comprises at least about 0.01% wt., yet more preferably at least about 0.1% wt, still more preferably an amount of at least about 0.2% wt., 0.3% wt., 0.4% wt., 0.5% wt., 0.6% wt., 0.7% wt., 0.8% wt., 0.9% wt. and 1% wt. of the said largely aqueous treatment compositions.

As noted the peroxygen compound constituent of the invention comprises, or in certain embodiments, consists of, hydrogen peroxide. Advantageously when two or more different peroxygen compounds are present in the largely aqueous treatment composition, then it is preferred that hydroperoxide or precursor or source thereof comprise at least 50% by weight of the peroxygen compound constituent, but more advantageously comprises at least 75% wt., and especially preferably comprises at least 80% wt., 85% wt., 90% wt., 95% wt., 97% wt., 98% wt., 99% wt. of the largely aqueous treatment composition of the invention.

The compositions of the invention necessarily include a betaine surfactant constituent, preferably selected from water dispersible and water soluble betaine surfactants. Exemplary betaine surfactants include those which may be represented by the general formula:

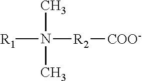

wherein R₁ is an alkyl group containing from 8 to 18 carbon atoms, or the amido radical which may be represented by the following general formula:

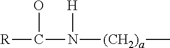

wherein R is an alkyl group having from 8 to 18 carbon atoms, a is an integer having a value of from 1 to 4 inclusive, and R₂ is a C₁-C₄ alkylene group. Examples of such water-soluble betaine surfactants include dodecyl dimethyl betaine, cocoamidopropyl betaine as well as cocoamidopropyl dimethyl betaine, the latter of which is particularly preferred. In certain preferred embodiments, cocoamidopropyl dimethyl betaine is particularly preferred and in specific especially preferred embodiments is the sole betaine surfactant present in the inventive compositions.

The betaine surfactant(s) present in the treatment compositions may comprise as little as 0.05% wt. but advantageously (and in order of increasing preference) comprise at least 0.1, 0.2, 0.3, 0.4, 0.5, 0.6, 0.7, 0.8, 0.9 and 1, each of the foregoing in % wt. Further, the betaine surfactant(s) may comprise as much as 5% wt., but preferably not in excess of (and in order of increasing preference) 4.5, 4, 3.5, 3, 2.75, 2.5, 2.25, 2, 1.9, 1.8, 1.7, 1.6, 1.5, 1.4, 1.3, 1.2, and 1.1, each of the foregoing in % wt.

The treatment compositions of the invention necessarily include at least one anionic surfactant in conjunction with the at least one betaine surfactant. The at least one anionic surfactant may be water soluble anionic sulfonate surfactants and include, but are not limited to: linear C₈-C₂₄ alkyl benzene sulfonates; C₈-C₂₄ paraffin sulfonates, alpha olefin sulfonates containing about 8 to about 24 carbon atoms and C₈-C₂₄ alkyl sulfates and mixtures thereof. These anionic surfactants may be present as water soluble or water dispersible salts, e.g., alkali metal or alkaline earth metal salts, such as sodium, potassium, ammonium, lithium magnesium as well as alkanolammonium salts of any of these aforementioned compounds.

The anionic surfactant may be any of the anionic surfactants known or previously used in the art of aqueous surfactant compositions. Suitable anionic surfactants include, but are not limited to: alkyl sulfates, alkyl ether sulfates, alkaryl sulfonates, alkyl succinates, alkyl sulfosuccinates, N-alkoyl sarcosinates, alkyl phosphates, alkyl ether phosphates, alkyl ether carboxylates, alkylamino acids, alkyl peptides, alkoyl taurates, carboxylic acids, acyl and alkyl glutamates, alkyl isethionates, and alpha-olefin sulfonates, especially their sodium, potassium, magnesium, ammonium and mono-, di- and triethanolamine salts. The alkyl groups generally contain about 8 to about 24 carbon atoms and may be unsaturated. These anionic surfactants may be provided as salts of one of these aforementioned compounds, which salts may render them, or improve their solubility or miscibility in water. Non-limiting examples of water soluble or water dispersible salts include alkali metal or alkaline earth metal salts, such as sodium, potassium, ammonium, lithium magnesium as well as alkanolammonium salts.

In certain preferred embodiments, the anionic surfactant(s) present in the compositions predominantly consist of one or more alkyl ethoxylated ether sulfates or salt form thereof. Such compounds include those which may be represented by either of the following formula I and II as follows:

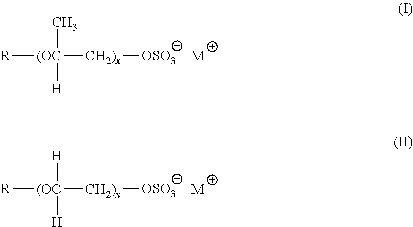

in which formulae, x has a value of from 1-22 inclusive, but preferably has a value of 1-10 inclusive, R is an alkyl group having 8-18 carbon atoms, and M is a radical or cation which renders the compound water soluble or water miscible, e.g., These anionic surfactants may be provided as salts of one of these aforementioned compounds, which salts may render them, or improve their solubility or miscibility in water. Non-limiting examples of water soluble or water dispersible salts include alkali metal or alkaline earth metal salts, such as sodium, potassium, ammonium, lithium magnesium as well as alkanolammonium salts.

The anionic surfactant(s) present in the treatment compositions may comprise as little as 0.05% wt. but advantageously (and in order of increasing preference) comprise at least 0.1, 0.25, 0.5, 0.75, 1, 1.25, 1.5, 2, 2.25, and 2.5, each of the foregoing in % wt. Further, the anionic surfactant(s) may comprise as much as 5% wt., but preferably not in excess of (and in order of increasing preference) 4.5, 4, 3.5, 3, 2.75, and 2.5 each of the foregoing in % wt.

An exemplary and preferred anionic surfactant is a lauryl ether sulfate, which is the predominant anionic surfactant present in the treatment compositions. Ideally, the lauryl ether sulfate surfactant comprises at least 50.1% wt, but preferably (in order of increasing preference) at least 55, 60, 65, 70, 75, 80, 85, 90, 95, 97.5, 98, 90.5, 99, 90.5% wt. of the total amount of the anionic surfactant(s) present in the compositions. Most preferably, the lauryl ether sulfate surfactant is the sole anionic surfactant present in the treatment compositions. The lauryl ether sulfate surfactant may be provided as a water soluble or water miscible salt, preferably as an alkali metal salt, such as a sodium, or potassium salt. Exemplary, commercially available sodium lauryl ether sulfate surfactant is presently available as CALFOAM ES 703 (ex. Pilot Chemical Co.)

The compositions of the invention also necessarily require a water-soluble or water dispersible inorganic salt, which function as a source of ions which interact with one or more of the further constituents present in order to increase the viscosity of the treatment compositions. It has been observed by the inventor that the presence of available ions favorably improve the thickening of the compositions, but at the same time do not undesirably detract from the storage stability of the liquid compositions. These ions may be added to the treatment compositions separately as a separate constituent, or they may be delivered as a part of a different material which is used in the liquid compositions and thereby become included in the same. Exemplary useful inorganic salts are water-soluble salts, including alkali metal salts, alkali hydroxides, alkali carbonates and alkali sulfates. Exemplary useful alkali metal salts include monovalent and divalent salts, such as one or more of: magnesium sulfate, calcium sulfate, potassium sulfate and sodium chloride. The inorganic salt, especially wherein the inorganic salt is an ion source and preferably is an alkali metal salt, may be present in the treatment compositions in any effective amount which increases the viscosity of the compositions as compared to the viscosity of the compositions were such an inorganic salt is omitted. Advantageously the water dispersible inorganic salts are present in an amount of between 0.01% wt. and 5% wt., preferably is present in an amount of from 0.05% wt. to 2% wt., still more preferably from about 0.1 to 1.75% wt. and yet more preferably is present in an amount of between about 0.05% wt. and 1.5% wt., based on the total weight of the treatment compositions of which they form a part. Especially preferred amounts are demonstrated with reference to one or more of the Example compositions provided hereinafter. While not wishing to be bound by theory it is believed by the present inventor that the inclusion of sodium chloride, which functions as an ion source, in the treatment compositions favorably interacts with both of the anionic surfactant, especially the preferred alkyl ethoxylated ether sulfates as well as with the betaine surfactant, especially the preferred cocoamido dimethyl betaine in order to provide an appreciable increase in the viscosity of the treatment compositions taught herein. This is achieved even in the absence of conventional thickeners, such as clays, as well as cellulose or cellulose derivatives, which any case considered by the art to be unsuitable or unstable in the presence of an oxidizing agent, such as hydrogen peroxide. Ideally then, according to preferred embodiments thickeners based on clays, as well as cellulose or cellulose derivatives are desirably excluded from the treatment compositions according to the invention.

The treatment compositions of the invention also further necessarily require one or more chelating agents and preferably such include those having three or more carboxylate moieties. Preferred chelating agents include one or more of Ethylene Diamine Tetra Acetic acid (EDTA), Diethylene Triamine Penta Acetic acid (DTPA), Ethane-1-hydroxy-1,1-diphosphonate (EHDP), Ethylene Diamine-N,N′-Disuccinate (EDDS), Nitrilo Triacetic Acid (NTA), Sodium Imino Disuccinate (IDS), Ethylene Glycol-bis-(2-aminoethyl)-N,N,N′,N′-Tetra Acetic acid (EGTA), Methyl Glycine Diacetic Acid (MGDA), N-(2-hydroxyethyl) Ethylene Diamine N,N′,N′-Thacetic acid) (HEDTA), Ethylene Diamine Tetra Methylene Phosphonic acid (EDTMP), Diethylene Thamine-Penta-Methylene Phosphonic acid (DTPMP), Glutamic acid-N,N-Diacetic Acid (GLDA), Cyclohexane-1,2-Diamine-N,N,N′,N′-Tetra-Acetic Acid (CDTA), 1,3-Propylenediamine Tetra-Acetic Acid (PDTA), Ethylene Diamine Triacetic Acid (EDTA), L-hydroxy Imino Disuccinic acid (L-IDS), Trisodium N-Carboxyethyl Imino Succinate (CEIS), Sodium Thpolyphosphate (STP), Thethylene Tetramine Hexaacetic Acid (TTHA). Other preferred chelating agents are Trisodium Ethylene Diamine Disuccinate, Tetra-sodium-Imino disuccinate, Glutamic acid-N,N diacetic acid tetra sodium salt, 2-hydroxyethyl iminodiacetic acid, Sodium salt (disodium ethanol diglycinate), Tetrasodium 3-hydroxy-2,2 imino disuccinate, Trisodium methylglycine diacetic acid, L-Aspartate-N,N-diacetic acid tetrasodium salt. Particularly preferred as chelating agents are succinate compounds, including those which may be represented by the formula;

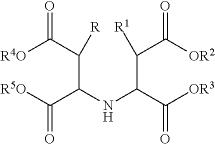

in which R, R¹, independently of one another, denote H or OH, R², R³, R⁴, R⁵, independently of one another, denote a cation, hydrogen, alkali metal ions and ammonium ions, ammonium ions having the general formula R⁶, R⁷, R⁸, R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. A preferred example is Iminodisuccinic acid (IDS) and (hydroxy)iminodisuccinic acid (HIDS) and alkali metal salts or ammonium salts thereof are especially preferred succinate based builder salts, of which iminodisuccinic acid is especially preferred. Such succinate compounds are known from and described in U.S. Pat. No. 5,977,053 the contents of which are herein incorporated by reference.

The chelating agent(s) present in the treatment compositions may comprise as little as 0.001% wt. but advantageously (and in order of increasing preference) comprise at least 0.01, 0.05, 0.1, each of the foregoing in % wt. Further, the chelating agent(s) may comprise as much as 1.5% wt., but preferably the chelating agent(s) is not in excess of (and in order of increasing preference) 1.25, 1, 0.9, 0.8, 0.7, 0.6, 0.5, 0.45, 0.4, 0.35, 0.3, 0.25, and 0.2, each of the foregoing in % wt.

According to certain preferred embodiments of the invention, one or more succinate compounds are the predominant or, more preferably the sole chelating agents present in the treatment compositions of the invention. Succinate compounds thus preferably comprise at least 50.1% wt, but preferably (in order of increasing preference) at least 55, 60, 65, 70, 75, 80, 85, 90, 95, 97.5, 98, 90.5, 99, 90.5% wt. of the total amount of the chelating agent(s) present in the compositions. In certain and preferred embodiments, one or more succinate compound(s) are the sole chelating agents present in the treatment compositions of the invention. In particularly preferred embodiments, the predominant chelating agent present in the invention is iminodisuccinic acid (IDS) and/or a salt form thereof.

The treatment compositions are also characterized in that they contain no organic acids comprising only one or two carboxylate moieties (—COOH), however the treatment compositions necessarily contain at least one inorganic acid which is maybe one or more inorganic acids. The acids useful in the treatment composition may be one or more water soluble inorganic acids, which are also to be understood as encompassing mineral acids with virtually all such known materials contemplated as being useful in the present inventive compositions. Exemplary inorganic acids include, e.g., phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate and sulfamic acid. Inorganic acids comprising the moiety: —SOOO⁻ or —SOOOH are preferred, and such include: alkyl, aryl, or alkaryl sulfonic acids, e.g., methane sulfonic acid, alkylbenzene sulfonic acid, Such sulfonic acids may be provided to the treatment composition by the in-situ neutralization of an organic compound such as an alkyl, aryl or alkaryl sulfonic acid with a neutralizing agent, such as a hydroxide (e.g., sodium hydroxide) which under a sufficiently low pH (e.g., pH of about 5 or less) may form a sulfonic acid and the corresponding alkyl, aryl or alkaryl sulfonate which may function as an anionic surfactant compound. Strong inorganic acids such as hydrochloric acid, nitric acid and sulfuric acid may also be used, however are less preferred due to their strong acidic character; if present are desirably present in only minor amounts.

Preferably the inorganic acid(s) is predominantly on or more alkyl, aryl, or alkaryl sulfonic acids, and comprises at least 50.1% wt, but preferably (in order of increasing preference) at least 55, 60, 65, 70, 75, 80, 85, 90, 95, 97.5, 98, 90.5, 99, 90.5% wt. of the total amount of the inorganic acid(s) present in the compositions. The alkyl, aryl, or alkaryl sulfonic acids may be provided as acids, or by in-situ formation via a neutralization reaction as discussed above.

The inorganic acid(s) may be present in any amount effective in imparting an acidic pH to the inventive compositions. The inorganic acid(s) may be present in any effective amount, but desirably is not present in amounts totaling more than about 5% wt. based on the total weight of the compositions. It is to be understood that the nature of the inorganic acid(s) selected to form the inorganic acid constituent will influence the amount of acid required to obtain a desired final pH or pH range, and the precise amount of inorganic acid(s) required for a specific composition can be readily obtained by a skilled artisan utilizing conventional techniques. Further, the amount of inorganic acid(s) present in the composition, keeping in mind any optional ingredients that may be present, should be in an amount such that the pH of the composition is about 5 or less, and especially within the preferred pH ranges of about 2 to about 4, preferably about 2.5-3.5. Particularly preferred pHs of the treatment compositions of the invention are disclosed with reference to the Examples. Generally however, the inclusion of the inorganic acid(s) in an amount of from about 0.001-3% wt., more preferably from about 0.75-2% wt. has yielded good results. Particularly preferred acids for use in the inorganic acid constituent and particularly preferred amounts thereof are also described with reference to one or more of the Examples.

As is noted above, the hard surface treatment compositions are largely aqueous in nature. Water is added to order to provide to 100% by weight of the largely aqueous treatment compositions. The water may be tap water, but is preferably distilled and is most preferably deionized water. If the water is tap water, it is preferably substantially free of any undesirable impurities such as organics or inorganics, especially minerals and salts which are present in hard water which may thus undesirably interfere with the operation of the constituents present in the treatment compositions. Advantageously, water provides at least 90% wt, and in order of increasing preference at least 91% wt., 92% wt., 93% wt., 94% wt., 95% wt., 96% wt., 97% wt. 98% wt., and 99% wt. of the inventive treatment compositions.

The compositions of the present invention can also optionally comprise one or more further constituents which are directed to improving the aesthetic or functional features of the inventive compositions. By way of non-limiting example such further constituents include one or more coloring agents, fragrances and fragrance solubilizers, viscosity modifying agents, other surfactants, pH adjusting agents and pH buffers including organic and inorganic salts, optical brighteners, hydrotropes, organic solvents, coloring agents, fragrances, certain thickeners, certain surfactants, and preservatives. When one or more of the optional constituents is added, i.e., fragrance and/or coloring agents, the esthetic and consumer appeal of the product is often favorably improved. The use and selection of these optional constituents is well known to those of ordinary skill in the art. When present, the one or more optional constituents present in the inventive compositions do not exceed about 25% wt., preferably do not exceed 50% wt., and most preferably do not exceed 25% wt. Preferred and particularly preferred optional constituents, and preferred and particularly preferred weight percentages are indicated in or more of the Examples.

Optionally but in many instances preferably, (and in some instances, essentially present in) the compositions of the invention are also present one or more further surfactants, and particularly one or more nonionic, amphoteric and zwitterionic surfactants. Cationic surfactants are desirably avoided as such would be expected to form insoluble complexes with the essential anionic surfactant present in the treatment composition.

Preferred surfactants include nonionic surfactants, especially one or more of the following types of nonionic surfactants. Non-limiting and illustrative examples of suitable nonionic surfactants for use include, inter alia, condensation products of alkylene oxide groups with an organic hydrophobic compound, such as an aliphatic compound or with an alkyl aromatic compound. The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic detergent. Further, the length of the polyethenoxy hydrophobic and hydrophilic elements may be varied to adjust these properties. Illustrative examples of such nonionic surfactants include the condensation product of one mole of an alkyl phenol having an alkyl group containing from 6 to 12 carbon atoms with from about 5 to 25 moles of an alkylene oxide. Another example of such a nonionic surfactant is the condensation product of one mole of an aliphatic alcohol which may be a primary, secondary or tertiary alcohol having from 6 to 18 carbon atoms with from 1 to about 10 moles of alkylene oxide. Preferred alkylene oxides are ethylene oxides or propylene oxides which may be present singly, or may be both present.

Still further illustrative examples of nonionic surfactants include primary and secondary linear and branched alcohol ethoxylates, such as those based on C₆-C₁₈ alcohols which further include an average of from 2 to 80 moles of ethoxylation per mol of alcohol. Examples include the Genapol® series of linear alcohol ethoxylates from Clariant Corp., Charlotte, N.C. The 26-L series is based on the formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water. Further examples of useful nonionic surfactants include secondary C₁₂-C₁₅ alcohol ethoxylates, including those which have from about 3 to about 10 moles of ethoxylation. Such are available in the Tergitol® series of nonionic surfactants (Dow Chemical, Midland, Mich.), particularly those in the Tergitol® “15-S-” series. Further exemplary nonionic surfactants include linear primary C₁₁-C₁₅ alcohol ethoxylates, including those which have from about 3 to about 10 moles of ethoxylation. Such are available in the Tomadol® series of nonionic surfactants under the following tradenames: Tomadol 1-3 (linear C₁₁ alcohol with 3 moles (average) of ethylene oxide); Tomadol 1-5 (linear C₁₁ alcohol with 5 moles (average) of ethylene oxide); Tomadol 1-7 (linear C₁₁ alcohol with 7 moles (average) of ethylene oxide); Tomadol 1-9 (linear C₁₁ alcohol with 9 moles (average) of ethylene oxide); Tomadol 23-1 (linear C₁₂₋₁₃ alcohol with 1 mole (average) of ethylene oxide); Tomadol 23-3 (linear C₁₂₋₁₃ alcohol with 3 moles (average) of ethylene oxide); Tomadol 23-5 (linear C₁₂₋₁₃ alcohol with 5 moles (average) of ethylene oxide); Tomadol 23-6.5 (linear C₁₂₋₁₃ alcohol with 6.6 moles (average) of ethylene oxide); Tomadol 25-12 (linear C₁₂₋₁₅ alcohol with 11.9 moles (average) of ethylene oxide); Tomadol 25-3 (linear C₁₂₋₁₅ alcohol with 2.8 moles (average) of ethylene oxide); Tomadol 25-7 (linear C₁₂₋₁₅ alcohol with 7.3 moles (average) of ethylene oxide); Tomadol 25-9 (linear C₁₂₋₁₅ alcohol with 8.9 moles (average) of ethylene oxide); Tomadol 45-13 (linear C₁₄₋₁₅ alcohol with 12.9 moles (average) of ethylene oxide); Tomadol 45-2.25 (linear C₁₄₋₁₅ alcohol with 2.23 moles (average) of ethylene oxide); Tomadol 45-7 (linear C₁₄₋₁₅ alcohol with 7 moles (average) of ethylene oxide); Tomadol 91-2.5 (linear C₉₋₁₁ alcohol with 2.7 moles (average) of ethylene oxide); Tomadol 91-6 (linear C₉₋₁₁ alcohol with 6 moles (average) of ethylene oxide); Tomadol 91-8 (linear C₉₋₁₁ alcohol with 8.3 moles (average) of ethylene oxide) (Tomah Products, Inc., Milton, Wis.).

Further examples of useful nonionic surfactants include C6-C15 straight chain alcohols ethoxylated with about 1 to 13 moles of ethylene oxide, particularly those which include about 3 to about 6 moles of ethylene oxide. Examples of such nonionic surfactants include Alfonic® 810-4.5, which is described as having an average molecular weight of 356, an ethylene oxide content of about 4.85 moles and an HLB of about 12; Alfonic® 810-2, which is described as having an average molecular weight of 242, an ethylene oxide content of about 2.1 moles and an HLB of about 12; and Alfonic® 610-3.5, which is described as having an average molecular weight of 276, an ethylene oxide content of about 3.1 moles, and an HLB of 10.

Further examples of suitable nonionic surfactants which may find use in the inventive compositions include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glycosides or polyglycosides. These compounds can be represented by the formula (S)ₙ—O—R wherein S is a sugar moiety such as glucose, fructose, mannose, and galactose; n is an integer of from about 1 to about 1000, and R is a C₈₋₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like. Commercially available examples of these surfactants include decyl polyglucoside (available as APG 325 CS from Henkel) and lauryl polyglucoside (available as APG 600 CS and 625 CS from Henkel).

A further class of nonionic surfactants which may find use in the present inventive compositions include ethoxylated octyl and nonyl phenols include those having one of the following general structural formulas:

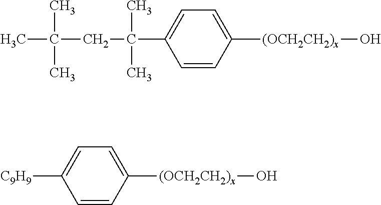

in which the C₉H₁₉ group in the latter formula is a mixture of branched chained isomers, and x indicates an average number of ethoxy units in the side chain. Particularly suitable non-ionic ethoxylated octyl and nonyl phenols include those having from about 7 to about 13 ethoxy groups. Such compounds are commercially available under the trade name Triton® X (Dow Chemical, Midland, Mich.), as well as under the tradename Igepal® (Rhodia, Princeton, N.J.). One exemplary and particularly preferred nonylphenol ethoxylate is Igepal® CO-630.

Still further examples of suitable nonionic surfactants include which may be advantageously included in the inventive compositions are alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where EO represents ethylene oxide,

PO represents propylene oxide,

y equals at least 15,
(EO)_{x+z} equals 20 to 50% of the total weight of said compounds, and,
the total molecular weight is preferably in the range of about 2000 to 15,000.

Another group of nonionic surfactants for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by formula (B) include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein R is an alkyl group containing 1 to 20 carbon atoms,

n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein n is about 5-15, preferably about 15,

x is about 5-15, preferably about 15, and

y is about 5-15, preferably about 15.

Still further useful nonionic surfactants include ethoxylated derivatives of propoxylated ethylene diamine, which may be represented by the following formula:

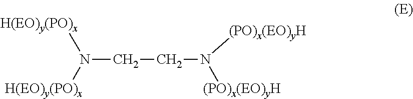

where (EO) represents ethoxy,

(PO) represents propoxy,

the amount of (PO)ₓ is such as to provide a molecular weight prior to ethoxylation of about 300 to 7500, and the amount of (EO)_{y} is such as to provide about 20% to 90% of the total weight of said compound.

Further examples of useful nonionic surfactants are one or more amine oxides. Exemplary amine oxides include:

A) Alkyl di (lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;

B) Alkyl di (hydroxy lower alkyl) amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl) tallowamine oxide; and bis(2-hydroxyethyl) stearylamine oxide;

C) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and

D) Alkylmorpholine oxides in which the alkyl group has about 10-20, and preferably 12-16 carbon atoms, and can be straight or branched chain, saturated or unsaturated.

Preferably the amine oxide constituent is an alkyl di (lower alkyl) amine oxide as denoted above and which may be represented by the following structure:

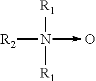

wherein each:

R₁ is a straight chained C₁-C₄ alkyl group, preferably both R₁ are methyl groups; and,

R₂ is a straight chained C₈-C₁₈ alkyl group, preferably is C₁₀-C₁₄ alkyl group, most preferably is a C₁₂ alkyl group.

Each of the alkyl groups may be linear or branched, but most preferably are linear. Technical grade mixtures of two or more amine oxides may be used, wherein amine oxides of varying chains of the R₂ group are present. Preferably, the amine oxides used in the present invention include R₂ groups which comprise at least 50% wt., preferably at least 60% wt. of C₁₂ alkyl groups and at least 25% wt. of C₁₄ alkyl groups, with not more than 15% wt. of C₁₆, C₁₈ or higher alkyl groups as the R₂ group.

Further specific examples of useful nonionic surfactants are alkanolamide surfactant compounds. Exemplary useful alkanolamides include one or more monoethanol amides, and diethanol amides of fatty acids having an acyl moiety which contains from about 8 to about 18 carbon atoms, and which may be represented in accordance with the formula:

R₁—CO—N(H)ₘ₋₁(R₂OF)₃₋ₘ

where R₁ represents a saturated or unsaturated aliphatic hydrocarbon radical of from about 7 to 21 carbon atoms, but preferably from about 11 to 17 carbon atoms; R₂ represents a —CH₂— or —CH₂CH₂—, and m is an integer from 1 to 3, but is preferably 1. Preferably, R₁ is a saturated or unsaturated aliphatic hydrocarbon radical comprising from about 11 to 17 carbon atoms, and m is 1. Specific examples of such compounds include mono-ethanol amine coconut fatty acid amide and diethanol amine dodecyl fatty acid amide. An exemplary useful and particularly preferred fatty acid amides include cocomonoethanol amide or cocodiethanolamide, which are presently commercially available as MONAMID CMA or MONAMID MDNA (ex. Mona Industries, Paterson N.J.). Further exemplary useful alkanolamides which provide such functions include inter alia: cocamide MEA, cocamide DEA, soyamide DEA, lauramide DEA, oleamide MIPA, stearamide MEA, myristamide MEA, lauramide MEA, capramide DEA, ricinoleamide DEA, myristamide DEA, stearamide DEA, oleylamide DEA, tallowamide DEA, lauramide MIPA, tallowamide MEA, isostearamide DEA, isostearamide MEA, and mixtures thereof. Further useful alkanolamide surfactant compounds include alkanolamides, particularly fatty monoalkanolamides and fatty dialkanolamides, including one or more of those marketed under the Ninol® tradename.

Further specific examples of useful nonionic surfactants include alkyl polyglycosides. The alkyl polyglycosides which can be used as nonionic surfactants in the composition are generally represented by the following formula I:

R₁O(R₂O)_{b}(Z)ₐ (I)

wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6. Preferred alkyl polyglycosides have the formula I wherein Z is a glucose residue and b is zero. Such alkyl polyglycosides are commercially available, for example, as APG®, GLUCOPON®, or PLANTAREN® surfactants from Cogis Corp. Specific examples of such surfactants include but are not limited to: APG® 225, described to be an alkyl polyglycoside in which the alkyl group contains 8 to 10 carbon atoms and having an average degree of polymerization of 1.7; GLUCOPON® 425, described to be an alkyl polyglycoside in which the alkyl group contains 8 to 16 carbon atoms and having an average degree of polymerization of 1.48; GLUCOPON® 625, described to be an alkyl polyglycoside in which the alkyl group contains 12 to 16 carbon atoms and having an average degree of polymerization of 1.6; APG® 325, described to be an alkyl polyglycoside in which the alkyl group contains 9 to 11 carbon atoms and having an average degree of polymerization of 1.5; GLUCOPON® 600, described to be an alkyl polyglycoside in which the alkyl group contains 12 to 16 carbon atoms and having an average degree of polymerization of 1.4; PLANTAREN® 2000, described to be an alkyl polyglycoside in which the alkyl group contains 8 to 16 carbon atoms and having an average degree of polymerization of 1.4; and, PLANTAREN® 1300, described to be an alkyl polyglycoside in which the alkyl group contains 12 to 16 carbon atoms and having an average degree of polymerization of 1.6. Other examples include alkyl polyglycoside surfactant compositions which are comprised of mixtures of compounds of formula I wherein Z represents a moiety derived from a reducing saccharide containing 5 or 6 carbon atoms; a is a number having a value from 1 to about 6; b is zero; and R.sub.1 is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycosides after removal of the alcohol. This separation may be carried out by molecular distillation and normally results in the removal of about 70-95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690, the entire contents of which are incorporated herein by reference.

Other alkyl polyglycosides which can be used in the compositions according to the invention are those in which the alkyl moiety contains from 6 to 18 carbon atoms in which and the average carbon chain length of the composition is from about 9 to about 14 comprising a mixture of two or more of at least binary components of alkylpolyglycosides, wherein each binary component is present in the mixture in relation to its average carbon chain length in an amount effective to provide the surfactant composition with the average carbon chain length of about 9 to about 14 and wherein at least one, or both binary components, comprise a Flory distribution of polyglycosides derived from an acid-catalyzed reaction of an alcohol containing 6-20 carbon atoms and a suitable saccharide from which excess alcohol has been separated.

Further exemplary nonionic surfactants which may be used include certain alkanolamides including monoethanolamides and diethanolamides, particularly fatty monoalkanolamides and fatty dialkanolamides. Commercially available monoethanol amides and diethanol amides include those marketed under the trade names Alakamide® and Cyclomide® by Rhône-Poulenc Co., (Cranbury, N.J.) and include Cyclomide® CDD-518 described to be a nonionic surfactant based on coconut diethanolamide; Cyclomide® C212 described to be a nonionic surfactant based on coconut monoethanolamide; Cyclomide® DC212 described to be a nonionic surfactant based on 2:1 coconut monoethanolamide; Cyclomide® DC212/M described to be a nonionic surfactant based on 2:1 modified coconut monoethanolamide; Cyclomide® DC212/S described to be a nonionic surfactant based on 1:1 coconut monoethanolamide; Cyclomide® DC212/SE described to be a nonionic surfactant based on 1:1 fatty acid diethanolamide; Cyclomide® DIN 100 described to be a nonionic surfactant based on lauric/linoleic diethanolamide; Cyclomide® DM-295/S described to be a nonionic surfactant based on 1:1 linoleic diethanolamide; Cyclomide® DL203 described to be a nonionic surfactant based on 2:1 lauric diethanolamide; Cyclomide® DL203/S described to be a nonionic surfactant based on 1:1 lauric diethanolamide; Cyclomide® DL207/S and Cyclomide® DL207/SL described to be nonionic surfactants based on 1:1 lauric/myristic diethanolamide; Cyclomide® DO280 described to be a nonionic surfactant based on 2:1 oleic diethanolamide; Cyclomide® DO280/S described to be a nonionic surfactant based on 1:1 oleic diethanolamide; Cyclomide® DS 280/S described to be a nonionic surfactant based on 1:1 stearic diethanolamide; Cyclomide® KD described to be a nonionic surfactant based on 1:1 coconut diethanolamide; Cyclomide® LE described to be a nonionic surfactant based on 1:1 lauric diethanolamide; Cyclomide® LIPA described to be a nonionic surfactant based on lauric monoisopropanolamide; Cyclomide® L203 described to be a nonionic surfactant based on lauric monoethanolamide; Cyclomide® S280 described to be a nonionic surfactant based on stearic monoethanolamide; Cyclomide® WRS 1-66 described to be a nonionic surfactant based on diethanolamides of unsaturated fatty acids; Cyclomide® 101 CG described to be an alkanolamide nonionic surfactant; Cyclomide® 200 CGN based on coconut oil diethanolamide; as well as Cyclomide® 206 CGN and Cyclomide® 210 CGN, both described to be a nonionic surfactants based on coconut alkanolamide.

The inventive compositions may desirably, although not always essentially, include at least one nonionic surfactant. An example of an especially preferred nonionic surfactant is at least one alcohol ethoxylate based nonionic surfactant in an amount of from about 0.01-10% wt. In order of increasing preference, when present, the at least one nonionic surfactant comprises in % wt. at least 0.025, 0.05, 0.075, 0.1, 0.2, 0.25, 0.3, 0.4, 0.5, 0.6, 0.75, 0.8, 0.9, 1, 1.1, 1.2, 1.3, 1.4 and 1.5% wt. and similarly in order of increasing preference the at least one nonionic surfactant comprises, in % wt., not more than 10, 9, 8, 7.5, 7, 6, 5, 4.75, 4.5, 4, 3.75, 3.5, 3.25, and 3% wt. based on the total weight of a treatment composition of which they form a part.

The treatment compositions of the invention may include one more pH adjusting agents. Preferably, the pH-adjusting agent is selected from the group consisting of a hydroxide, a hydroxide generator, a buffer, and a mixture of same. Appropriate pH-adjusting agents include alkali metal salts of various inorganic acids, such as alkali metal phosphates, polyphosphates, pyrophosphates, triphosphates, tetraphosphates, silicates, metasilicates, polysilicates, borates, carbonates, bicarbonates, hydroxides, and mixtures of same. A preferred pH-adjusting agent is an alkali metal hydroxide, especially sodium hydroxide which in addition to providing a pH adjusting benefit may be used to neutralize certain organic compounds as disclosed above. Also suitable as pH-adjusting agents are monoethanolamine compounds, such as diethanolamine and triethanolamine, and beta-aminoalkanol compounds, particularly beta-aminoalkanols having a primary hydroxyl group, and a mixture thereof. While the pH adjusting agent(s) may be present in any effective amount, advantageously they comprise up to 5% wt. of the treatment compositions, and when present, preferably between about 0.001-3.5% wt. of the treatment composition of which they form a part.

One or more coloring agents may also be used in the inventive compositions in order to impart a desired colored appearance or colored tint to the compositions. Known art water soluble or water dispersible us and dyes may be added in effective amounts. The compositions of the invention optionally but in certain cases desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C₅H₈)ₙ and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

The compositions of the invention may include one or more organic solvents, although in preferred embodiments none are needed. When present, preferred solvents comprise alcohols, glycols, glycol ether materials. Such materials tend to have aliphatic moieties containing 2 to 6 carbon atoms. Examples of such materials include ethanol, propanol, isopropanol, butanol, 2-butanol, 2-methyl-2-propanol, butoxy diglycol, ethoxy diglycol, polypropylene glycol, ethylene glycol methyl ether, ethylene glycol dimethyl ether, propylene glycol methyl ether, dipropylene glycol n-butyl ether, butoxy ethanol, phenoxy ethanol, methoxy propanol, propylene glycol, n-butyl ether, tripropylene glycol, n-butyl ether, propylene glycol, hexylene glycol and other similar oxygenated solvents. When present the one or more organic solvents may comprise to about 7.5% wt. of the treatment composition, and preferably 0.001-5% wt. of which it forms a part.

The inventive compositions may include a hydrotrope constituent comprising one or more compounds which exhibit a hydrotropic functionality in the inventive compositions. Exemplary hydrotropes include, inter alia, benzene sulfonates, naphthalene sulfonates, C₁-C₁₁ alkyl benzene sulfonates, naphthalene sulfonates, C₅-C₁₁ alkyl sulfonates, C₆-C₁₁ alkyl sulfates, alkyl diphenyloxide disulfonates, and phosphate ester hydrotropes. The hydrotropic compounds of the invention are often provided in a salt form with a suitable counterion, such as one or more alkali, or alkali earth metals, such as sodium or potassium, especially sodium. However, other water soluble cations such as ammonium, mono-, di- and tri-lower alkyl, i.e., C₁₋₄ alkanol ammonium groups can be used in the place of the alkali metal cations. Exemplary alkyl benzene sulfonates include, for example, isopropylbenzene sulfonates, xylene sulfonates, toluene sulfonates, cumene sulfonates, as well as mixtures thereof. Exemplary C₅-C₁₁ alkyl sulfonates include hexyl sulfonates, octyl sulfonates, and hexyl/octyl sulfonates, and mixtures thereof. Particularly useful hydrotrope compounds include benzene sulfonates, o-toluene sulfonates, m-toluene sulfonates, and p-toluene sulfonates; 2,3-xylene sulfonates, 2,4-xylene sulfonates, and 4,6-xylene sulfonates; cumene sulfonates, wherein such exemplary hydrotropes are generally in a salt form thereof, including sodium and potassium salt forms. When present the hydrotrope constituent may be present in any effective amounts, or they may be omitted. Advantageously, when present, the hydrotrope constituent comprises 0.001-1% wt. of the composition of which it forms a part.

Although normally not required, due to the low pH of the compositions, the driven compositions of the invention may optionally contain one or more preservatives. Such preservatives are primarily included to reduce the growth of undesired microorganisms within the composition during storage prior to use. Exemplary useful preservatives include compositions which include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. Further exemplary useful preservatives include those which are commercially including a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful and commercially available preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa.). When present this may be included in effective amounts, and advantageously when present to one or more preservative compositions of preparations are present amounts of from about 0.001-1% wt. Based on the weight treatment composition which it forms a part.

The treatment compositions taught herein may be further thickened, if desired, by the inclusion of an optional thickener based on polycarboxylate polymers. Examples of such polycarboxylate polymer thickeners include those having a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

The polycarboxylate polymer can be a non-associative thickener or stabilizer, such as a homopolymer or a copolymer of an olefinically unsaturated carboxylic acid or anhydride monomers containing at least one activated carbon to carbon olefinic double bond and at least one carboxyl group or an alkali soluble acrylic emulsion, or an associative thickener or stabilizer, such as a hydrophobically modified alkali soluble acrylic emulsion or a hydrophobically modified nonionic polyol polymer, i.e., a hydrophobically modified urethane polymer, or combinations thereof. The copolymers are preferably of a polycarboxylic acid monomer and a hydrophobic monomer. The preferred carboxylic acid is acrylic acid. The homopolymers and copolymers preferably are crosslinked.

Homopolymers of polyacrylic acid are described, for example, in U.S. Pat. No. 2,798,053. Examples of homopolymers which are useful include Carbopol® 934, 940, 941, Ultrez 10, ETD 2050, and 974P polymers, which are available from Noveon. Such polymers are homopolymers of unsaturated, polymerizable carboxylic monomers such as acrylic acid, methacrylic acid, maleic acid, itaconic acid, maleic anhydride, and the like.

Hydrophobically modified polyacrylic acid polymers are described, for example, in U.S. Pat. Nos. 3,915,921, 4,421,902, 4,509,949, 4,923,940, 4,996,274, 5,004,598, and 5,349,030. These polymers have a large water-loving hydrophilic portion (the polyacrylic acid portion) and a smaller oil-loving hydrophobic portion (which can be derived from a long carbon chain acrylate ester). Representative higher alkyl acrylic esters are decyl acrylate, lauryl acrylate, stearyl acrylate, behenyl acrylate and melissyl acrylate, and the corresponding methacrylates. It should be understood that more than one carboxylic monomer and more than one acrylate ester or vinyl ester or ether or styrenic can be used in the monomer charge. The polymers can be dispersed in water and neutralized with base to thicken the aqueous composition, form a gel, or emulsify or suspend a deliverable. Useful polymers are sold as Carbopol® 1342 and 1382 and Pemulen® TR-1, TR-2, 1621, and 1622, all available from Noveon. The carboxyl containing polymers are prepared from monomers containing at least one activated vinyl group and a carboxyl group, and would include copolymers of polymerizable carboxylic monomers with acrylate esters, acrylamides, alkylated acrylamides, olefins, vinyl esters, vinyl ethers, or styrenics. The carboxyl containing polymers have molecular weights greater than about 500 to as high as several billion, or more, usually greater than about 10,000 to 900,000 or more.

Also useful are interpolymers of hydrophobically modified monomers and steric stabilizing polymeric surface active agents having at least one hydrophilic moiety and at least one hydrophobic moiety or a linear block or random comb configuration or mixtures thereof. Examples of steric stabilizers which can be used are Hypermer®, which is a poly(12-hydroxystearic acid) polymer, available from Imperial Chemical Industries Inc. and Pecosil®, which is a methyl-3-polyethoxypropyl siloxane-ω-phosphate polymer, available from Phoenix Chemical, Somerville, N.J. These are taught by U.S. Pat. Nos. 4,203,877 and 5,349,030, the disclosures of which are incorporated herein by reference.

The polymers can be crosslinked in a manner known in the art by including, in the monomer charge, a suitable crosslinker in amount of about 0.1 to 4%, preferably 0.2 to 1% by weight based on the combined weight of the carboxylic monomer and the comonomer(s). The crosslinker is selected from polymerizable monomers which contain a polymerizable vinyl group and at least one other polymerizable group. Polymerization of the carboxyl-containing monomers is usually carried out in a catalyzed, free radical polymerization process, usually in inert diluents, as is known in the art.

Other polycarboxylic acid polymer compositions which can be employed include, for example, crosslinked copolymers of acrylates, (meth)acrylic acid, maleic anhydride, and various combinations thereof. Commercial polymers are available from Rheox Inc., Highstown, N.J. (such as Rheolate® 5000 polymer), 3 V Sigma, Bergamo, Italy (such as Stabelyn® 30 polymer, which is an acrylic acid/vinyl ester copolymer, or Polygel® and Synthalen® polymers, which are crosslinked acrylic acid polymers and copolymers), Noveon (such as Carbopol 674 (lightly crosslinked polyacrylate polymer), Carbopol 676 (highly crosslinked polyacrylate polymer), Carbopol EP-1 thickener, which is a acrylic emulsion thickener), or Rohm and Haas (such as Acrysol® ICS-1 and Aculyn® 22 thickeners, which are hydrophobically modified alkali-soluble acrylic polymer emulsions and Aculyn® 44 thickener, which is a hydrophobically modified nonionic polyol). Preferred are the Carbopol® and Pemulen® polymers, generally. The choice of the specific polymer to be employed will depend upon the desired rheology of the composition, and the identity of other compositional ingredients.

Whereas the compositions of the present invention are intended to be used in the types of liquid forms described, nothing in this specification shall be understood as to limit the use of the composition according to the invention with a further amount of water to form a cleaning solution therefrom. In such a proposed diluted cleaning solution, the greater the proportion of water added to form said cleaning dilution will, the greater may be the reduction of the rate and/or efficacy of the thus formed cleaning solution. Accordingly, longer residence times upon the stain to effect their loosening and/or the usage of greater amounts may be necessitated. Conversely, nothing in the specification shall be also understood to limit the forming of a “super-concentrated” cleaning composition based upon the composition described above. Such a super-concentrated ingredient composition is essentially the same as the cleaning compositions described above except in that they include a lesser amount of water.

The compositions of the present invention can be packaged in a suitable container to suit its viscosity and intended use by the consumer. For example, the composition may be packaged in a bottle, or can be packaged with a propellant in a propellant-driven aerosol device or alternately may be packaged in a container fitted with a manually operable pump. Advantageously the compositions are provided in bottles or flasks from which they be dispensed by pouring, or by pumping such as via a manually pumpable trigger pump or manually operable trigger spray pump. The inventive composition is preferably provided in a squeezable container, such as a flask or deformable bottle which provides for easy dispensing of the composition by the consumer, as in preferred embodiments the compositions are readily pourable at room temperature and while slightly viscous are preferably not thixotropic in character. Thus a further aspect of the invention provides a closed container containing the inventive composition as described herein.

The compositions of the present invention, whether as described herein or in a concentrate or super concentrate form, can also be applied to a hard surface by the use of a carrier substrate. One example of a useful carrier substrate is a wet wipe. The wipe can be of a woven or non-woven nature. Fabric substrates can include nonwoven or woven pouches, sponges including both closed cell and open celled sponges, including sponges formed from celluloses as well as other polymeric material, as well as in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former. The carrier substrate useful with the present inventive compositions may also be a wipe which includes a film forming substrate such as a water soluble polymer. Such self-supporting film substrates may be sandwiched between layers of fabric substrates and heat sealed to form a useful substrate.

The compositions of the present invention are advantageously absorbed onto the carrier substrate, i.e., a wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions. In use, a wipe is removed from the container and then wiped across an area in need of treatment; in case of difficult to treat stains the wipe may be re-wiped across the area in need of treatment, or a plurality of saturated wipes may also be used.

Such a hard surface cleaning compositions according to the invention may be may be directly applied to a hard surface. By way of example, hard surfaces include surfaces composed of refractory materials such as: glazed and unglazed tile, brick, porcelain, ceramics as well as stone including marble, granite, and other stones surfaces; glass; metals; plastics e.g. polyester, vinyl; fiberglass, Formica®, Corian® and other hard surfaces known to the industry. Hard surfaces which are to be particularly denoted are lavatory fixtures such as shower stalls, bathtubs and bathing appliances (racks, curtains, shower doors, shower bars) toilets, bidets, wall and flooring surfaces especially those which include refractory materials and the like. Further hard surfaces which are to be denoted are those associated with kitchen environments and other environments associated with food preparation, including cabinets and countertop surfaces as well as walls and floor surfaces especially those which include refractory materials, plastics, Formica®, Corian® and stone. Such hard surfaces described above are to be understood as being recited by way of illustration and not be way of limitation.

The viscous compositions are particularly adapted for the claim treatment of heart surfaces, particularly inclined hard services such as may be, lavatory appliances and in particular especially toilet bowls, bidets and urinals. The viscous nature of the treatment compositions allow for their attention upon such surfaces and thereby may be used to provide an increased cleaning and/or antimicrobial benefit.

In preferred embodiments, the treatment compositions of the invention also provide an antimicrobial benefit against gram-positive and/or gram-negative bacteria. Additionally, in preferred embodiments the treatment compositions of the invention also provide further anti-pathogenic efficacy against undesirable microorganisms.

Certain embodiments of the invention, including certain particularly preferred embodiments of the invention are disclosed in the following examples.

### EXAMPLES

A number of formulations were produced by mixing the constituents outlined in Table 1 by adding the individual constituents into a beaker of deionized water at room temperature which was stirred with a conventional magnetic stirring rod. Stirring continued until the formulation was homogenous in appearance. It is to be noted that the constituents might be added in any order, but it is preferred that a first premixture is made of any fragrance constituent with one or more surfactants used in the inventive compositions. Thereafter, a major amount of water is first provided to a suitable mixing vessel or apparatus as it is the major constituent and thereafter the further constituents are added thereto convenient. The order of addition is not critical, but good results are obtained where the surfactants (which may be also the premixture of the fragrance and surfactants) are added to the water prior to the remaining constituents. In these identified compositions, the constituents were used “as supplied” from their respective suppliers and may constitute less than 100% wt. “actives”, or may have been supplied as constituting 100% wt. “active” of the named compound, as indicated below.

Treatment compositions which are considered to fall within the scope of the present invention are identified by a digit prepended with the letter “E” which indicates this to be an “example” composition, while compositions provided only for the purposes of comparison are identified by a digit prepended with the letter “C”, which indicates this to be a comparative composition and falling outside of the scope of the present invention. In the treatment compositions, deionized water was added in “quantum sufficient” “q.s.” in order to provide to 100% wt. of each composition. The compositions disclosed according to the invention, include certain presently preferred embodiments of the invention.

TABLE 1

| | C1 | C2 | C3 | C4 | C5 | C6 | C7 | C8 |
|---|---|---|---|---|---|---|---|---|
| hydrogen peroxide | — | — | — | — | 3.0 | 3.0 | 0.5 | 3.0 |
| (50%) | | | | | | | | |
| hydrogen peroxide | 5.7 | 5.7 | 8.57 | 8.6 | — | — | — | — |
| (30%) | | | | | | | | |
| xantham gum (Kelzan | 0.4 | — | — | — | — | — | — | — |
| ASX T) | | | | | | | | |
| Acusol 880 | — | 0.25 | — | — | 3.6 | 1.0 | — | — |
| hydroxyethyl cellulose | — | — | 0.45 | — | — | — | — | — |
| Carbopol Aqua 30 | — | — | — | — | — | — | 1.6 | 1.6 |
| (30%) | | | | | | | | |
| nonionic alcohol | 5.0 | 5.0 | — | — | — | — | — | — |
| ethoxylate | | | | | | | | |
| amine oxide | — | — | | 6.4 | — | — | — | — |
| nonionic alcohol | — | — | 2.0 | — | 1.0 | 1.0 | — | 5.0 |
| ethoxylated(2) | | | | | | | | |
| alkylbenzene sulfonate | — | — | — | — | 5.0 | 5.0 | 10.0 | — |
| (38%) | | | | | | | | |
| glycol ether solvent | — | — | — | — | — | 2.0 | — | — |
| cocoamidopropyl | — | — | — | — | — | — | — | — |
| dimethyl betaine (30%) | | | | | | | | |
| sodium lauryl ether | — | — | — | — | — | — | 5.0 | 5.0 |
| sulfate (70%) | | | | | | | | |
| IDS | 0.4 | 0.4 | 0.4 | 0.4 | 0.4 | 0.4 | 0.4 | 1.5 |
| sodium chloride | — | — | — | 5.0 | — | — | — | — |
| sodium hydroxide (25%) | — | — | 2.04 | — | — | — | — | — |
| sodium hydroxide (50%) | — | — | — | — | — | — | 3.0 | 0.5 |
| citric acid | 3.0 | 3.0 | 5.0 | 5.0 | 3.0 | 3.0 | 3.0 | 3.0 |
| fragrance | 0.25 | 0.25 | 0.15 | 0.25 | 0.15 | 0.15 | 0.15 | 0.15 |
| colorant | — | — | — | — | 0.006 | 0.006 | 0.006 | 0.006 |
| di water | q.s. | q.s. | q.s. | q.s. | q.s. | q.s. | q.s. | q.s. |
| pH | n.t.* | n.t.* | n.t.* | n.t.* | n.t.* | n.t.* | n.t.* | n.t.* |
| available hydrogen | n.t.* | n.t.* | n.t.* | n.t.* | n.t.* | n.t.* | n.t.* | n.t.* |
| peroxide (% wt.) | | | | | | | | |
| viscosity** | n.t.* | n.t.* | n.t.* | n.t.* | n.t.* | n.t.* | n.t.* | n.t.* |
| Notes | excessive | excessive | excessive | excessive | did not | did not | did not | did not |
| | bloating in | bloating in | bloating in | bloating in | thicken to | thicken to | thicken to | thicken to |
| | 1 week at | 1 week at | 1 week at | 1 week at | desired | desired | desired | desired |
| | 40° C. | 40° C. | 40° C. | 40° C. | viscosity | viscosity | viscosity | viscosity |

*indicated that the sample was not tested
**viscosity measured at room temperature (20° C.), using Brookfield Type DV II Viscometer, #2 spindle, 30 rpm (unless otherwise indicated)

TABLE 1

| | E1 | E2 | E3 | E4 | E5 |
|---|---|---|---|---|---|
| hydrogen peroxide | 2.72 | 2.72 | 2.72 | 2.68 | 2.76 |
| (50%) | | | | | |
| cocoamidopropyl | 3.1 | 3.1 | 3.1 | 3.1 | 3.1 |
| dimethyl betaine (30%) | | | | | |
| sodium lauryl ether | 3.9 | 3.9 | 3.9 | 3.9 | 3.9 |
| sulfate (70%) | | | | | |
| IDS | 0.4 | 0.4 | 0.4 | 0.4 | 0.4 |
| sodium chloride | 1.33 | 3.02 | 3.02 | 1.38 | 1.38 |
| alkyl benzene sulfonic | 1.4 | — | 1.4 | 1.4 | 1.4 |
| acid (96%) | | | | | |
| sulfamic acid | — | 0.4 | — | — | |
| sodium hydroxide (50%) | 0.1 | — | 0.2 | 0.1 | 0.1 |
| fragrance | 0.15 | 0.15 | 0.15 | 0.15 | 0.15 |
| colorant | 1.09 | 1.09 | 1.09 | 1.09 | 0.011 |
| di water | q.s. | q.s. | q.s. | q.s. | q.s. |
| pH (initial, as mixed) | 2.79 | 2.37 | 3.2 | 2.79 | 2.79 |
| Viscosity (cPs) | 843.9 | 945.8 | 1065 | 843.9 | 839.9 |

The identity of the constituents utilized in producing the compositions of Table 1 are disclosed on the following Table 2. All of the constituents were used “as supplied” from their respective manufacturer unless indicated otherwise. The weight percentage “actives” within each constituent was 100% wt., unless indicated otherwise on Table 1 and/or Table 2.

TABLE 2

| | |
|---|---|
| hydrogen peroxide | aqueous solution of hydrogen peroxide supplied as |
| (50%) | Peroxal Bio 50% (50% wt. actives) (ex. Arkema) |
| hydrogen peroxide | aqueous solution of hydrogen peroxide (30% wt. actives) |
| (30%) | |
| cocoamidopropyl | cocoamidopropyl dimethyl betaine, supplied as Empigen |
| dimethyl betaine (30%) | BS/FA (30% wt. actives) (ex. Cognis) |
| sodium lauryl ether | sodium lauryl ether sulfate, avg. 3EO, supplied as |
| sulfate (70%) | Calfoam ES 703 (70% wt. actives) (ex. Pilot Chem. Co.) |
| alkylbenzene sulfonate | anionic surfactant, sodium alkylbenzene sulfonate, (38% |
| (38%) | wt. actives), supplied as Biosoft D-40 (ex. Stepan Co.) |
| nonionic alcohol | nonionic C9-C11 ethoxylated surfactant, 6 mols |
| ethoxylate | ethoxylation (100% wt. actives) supplied as Neodol 91-6 |
| nonionic alcohol | nonionic linear C14-15 ethoxylated alcohol with 7 moles |
| ethoxylate (2) | (average) ethoxylation, (100% wt. actives) supplied as |
| | Tomadol 45-7 |
| amine oxide | myristyldimethylamine oxide (30% wt. active) supplied as |
| | Ammonyx MO (ex. Stepan) |
| IDS | sodium imino disuccinate (34% wt. actives) (ex. Lanxess) |
| sodium chloride | laboratory grade sodium chloride (100% wt. actives) |
| alkyl benzene sulfonic | alkyl benzene sulfonic acid, supplied as Biosoft S101 |
| acid (96%) | (96% wt. actives) (ex. Stepan Co.) |
| sulfamic acid | laboratory grade sulfamic acid, (99.5% wt. actives) |
| sodium hydroxide (50%) | aqueous solution or dispersion of NaOH (50% wt. actives) |
| sodium hydroxide (25%) | aqueous solution or dispersion of NaOH (25% wt. actives) |
| xantham gum (Kelzan | xantham gum (100% wt. actives) supplied as Kelzan ASX |
| ASX T) | T (ex. Kelco) |
| hydroxyethyl cellulose | hydroxyethyl cellulose (100% wt. actives) |
| Carbopol Aqua 30 | polyacrylate polymer (30% wt. actives) supplied as |
| (30%) | Carbopol Aqua 30 |
| Acusol 880 | polymeric thickener comprising 34-36% modified |
| | polyethylene glycol, 38-40% propanediol, 25-27% wt. |
| | water (ex. DOW Chem. Co.) |
| glycol ether solvent | dipropylene glycol n-butyl ether, (100% wt. actives) |
| | supplied as Dowanol DPnB |
| citric acid | anhydrous citric acid, laboratory grade |
| fragrance | proprietary composition of its supplier |
| colorant | 1% wt. aqueous dispersion of inorganic pigment |
| di water | deionized water, supplied in “quantum sufficient” to |
| | provide 100% wt. of the indicated composition |

The pH and viscosity of the “as mixed” compositions of E2 and E3 of Table 1 are reported on Table 1. Additionally, the pH, viscosity, and available hydrogen peroxide as well as the appearance of the E1 composition was tested both initially (“as mixed”) and at periodic weekly intervals thereafter, with separate aliquots of the E1 composition being stored at different temperatures. The separate aliquots of the E1 composition were stored at one of the following temperatures: 4° C., 25° C., 30° C., 40° C., and 50° C. over the span of several weeks. At the time intervals indicated on Table 3, a sample was removed from the indicated storage temperature, allowed to equilibrate to room temperature (20° C.) and thereafter tested, with the indicated results reported on the table. The viscosity was measured at room temperature (20° C.), using Brookfield Type DV II Viscometer, #2 spindle, 30 rpm. The color and the appearance of the samples were visually observed and noted. Additionally a sample of the E1 composition was subjected to a freeze-thaw cycle (indicated as storage condition (“F/T”) wherein the sample was completely frozen, stored for the indicated time interval, thereafter allowed to thaw and allowed to equilibrate to room temperature (20° C.) for 24 hours and thereafter tested, with the indicated results reported on the table. Subsequently the sample was then refrozen, stored until the next indicated time interval, again allowed to equilibrate and tested. It is to be noted that two aliquots of the E1 composition were tested for the amount of available hydrogen peroxide present, and the results were averaged and reported on the following Table 3. Evaluation of available hydrogen peroxide was performed by titration.

TABLE 3

| storage temperature | 20° C. | 4° C. | 25° C. | 30° C. | 40° C. | 50° C. | F/T |
|---|---|---|---|---|---|---|---|
| Initial: | | | | | | | |
| pH | 2.79 | | | | | | |
| viscosity (cPs) | 843.9 | | | | | | |
| % available | 1.33 | | | | | | |
| H₂O₂ | | | | | | | |
| color | bright | | | | | | |
| | blue | | | | | | |
| appearance | thick, | | | | | | |
| | viscous | | | | | | |
| 2 week storage | | | | | | | |
| pH | 2.79 | 2.79 | 2.82 | 2.83 | 2.86 | 3.05 | 2.87 |
| viscosity (cPs) | 843.9 | 603.9 | 520.9 | 490.9 | 329.9 | 218 | 618.9 |
| % available | 1.33 | 1.33 | 1.31 | 1.31 | 1.31 | 1.29 | 1.31 |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |
| 3 week storage | | | | | | | |
| pH | 2.79 | 2.82 | 2.83 | 2.86 | 2.89 | 2.91 | 2.74 |
| viscosity (cPs) | 843.9 | 576.9 | 510.9 | 479.9 | 265.9 | 182 | 636.9 |
| % available | 1.33 | 1.33 | 1.34 | 1.33 | 1.32 | 1.30 | 1.33 |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |
| 4 week storage | | | | | | | |
| pH | 2.79 | 2.72 | 2.77 | 2.79 | 2.93 | 3.03 | 2.74 |
| viscosity (cPs) | 843.9 | 456.9 | 358.9 | 341.9 | 188 | 138 | 501.9 |
| % available | 1.33 | 1.32 | 1.32 | 1.31 | 1.31 | 1.29 | 1.33 |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |
| 5 week storage | | | | | | | |
| pH | 2.79 | 2.79 | 2.87 | 2.89 | 2.98 | 3.16 | n.t.* |
| viscosity (cPs) | 843.9 | 535.9 | 380.9 | 350.9 | 174.0 | 157.9 | n.t.* |
| % available | 1.33 | 1.31 | 1.33 | 1.31 | 1.31 | 1.29 | n.t.* |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |
| 6 week storage | | | | | | | |
| pH | 2.79 | 2.88 | 2.88 | 2.89 | 3.00 | 3.17 | n.t.* |
| viscosity (cPs) | 843.9 | 652.9 | 405.9 | 329.9 | 153.0 | 211.0 | n.t.* |
| % available | 1.33 | 1.32 | 1.29 | 1.30 | 1.30 | 1.25 | n.t.* |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |
| 7 week storage | | | | | | | |
| pH | 2.79 | 2.85 | 2.78 | 2.90 | 3.03 | 3.17 | n.t.* |
| viscosity (cPs) | 843.9 | 434.9 | 289.9 | 233.0 | 122.0 | 300.9 | n.t.* |
| % available | 1.33 | 1.33 | 1.26 | 1.34 | 1.34 | 1.21 | n.t.* |
| H₂O₂ | | | | | | | |
| color | bright | bright | bright | bright | bright | bright | bright |
| | blue | blue | blue | blue | blue | blue | blue |
| appearance | thick, | thick, | thick, | thick, | thick, | thick, | thick, |
| | viscous | viscous | viscous | viscous | viscous | viscous | viscous |

*indicated that the sample was not tested

As is clearly understood from the reports resulted from Table 3, the compositions of the invention exhibited excellent retention of available hydrogen peroxide even under adverse storage conditions for multiple weeks, including at high temperatures. Additionally when visually observed the compositions appeared to retain their color, notwithstanding the presence of a peroxygen compound but also appeared to be thick and viscous when poured from a container.

Additionally, 700 ml (23.66 fluid ounce) samples of the E1 composition were mixed, and placed into a series of flexible blow molded bottles, and sealed with a gas-tight cap. Sufficient amount of the E1 composition was supplied to each of the bottles to provide a consistent amount of available headspace in the bottles (approx. 10% by volume), prior to sealing. The bottles and caps used were identical, and the bottles had a nominal fluid volume of 24 fluid ounces (actual fill capacity was 27.05 fluid ounces=800 ml). The bottles had two generally planar opposing sidewalls which were the point at which the thickness of the plastic was the least, thus making this part of the bottle most responsive to internal pressures and most resilient. At the midpoints of the exterior of the two generally planar opposing sidewalls of these bottles were placed a mark using a waterproof marker and each of the bottles was similarly marked with these two reference points. Thereafter a digital caliper could be used to measure the width of the bottle between these two reference points. The bottles containing the E1 compositions were measured after the initial filling at room temperature (20° C.) and the measurement was noted. Thereafter the filled bottles containing the E1 composition were stored at one of the following temperatures: 4° C., 25° C., 30° C., 40° C., and 50° C. over the span of several weeks. At the time intervals indicated on Table 4, each bottle was removed from the indicated storage temperature, allowed to equilibrate to room temperature (approx. 20° C.) for 24 hours, then measured utilizing the digital caliper, with the indicated results reported on the table. As indicated on Table 4, the reading (in millimeters) at a particularly weekly interval was recorded and the % gain was representative of the degree of “bloating” of the bottle, which in part is believed to be attributable to the amount of gas evolved from the E1 composition and trapped within the sealed, flexible blow molded bottles.

TABLE 4

| storage | | | | | | |
|---|---|---|---|---|---|---|
| temperature | 4° C. | 25° C. | 30° C. | 40° C. | 50° C. | F/T |
| initial caliper | 56.71 | 55.81 | 56.13 | 56.25 | 56.13 | |
| reading (mm) | | | | | | |
| 1 week storage | | | | | | |
| caliper reading | 56.04 | 55.81 | 56.13 | 56.28 | 60.29 | 56.15 |
| (mm) | | | | | | |
| % gain | −1 | 0 | 0 | 0 | 7 | 0 |
| 3 week storage | | | | | | |
| caliper reading | 56.45 | 55.96 | 56.29 | 58.58 | 63.98 | 55.7 |
| (mm) | | | | | | |
| % gain | 0 | 0 | 0 | 4 | 14 | −1 |
| 4 week storage | | | | | | |
| caliper reading | 56.49 | 55.85 | 56.41 | 59.4 | 61.9 | 55.3 |
| (mm) | | | | | | |
| % gain | 0 | 0 | 0 | 6 | 10 | −2 |
| 5 week storage | | | | | | |
| caliper reading | 56.7 | 56.13 | 56.35 | 60.04 | 61.78 | n.t.* |
| (mm) | | | | | | |
| % gain | 0 | 1 | 0 | 7 | 10 | n.t.* |
| 6 week storage | | | | | | |
| caliper reading | 57.03 | 55.95 | 57.21 | 62.49 | 64.51 | n.t.* |
| (mm) | | | | | | |
| % gain | 1 | 0 | 2 | 11 | 15 | n.t.* |
| 7 week storage | | | | | | |
| caliper reading | 57.02 | 55.92 | 57.1 | 59.61 | 60.29 | n.t.* |
| (mm) | | | | | | |
| % gain | 1 | 0 | 2 | 6 | 7 | n.t.* |

*indicated that the sample was not tested

In a further test, further 945 ml (32 fluid ounce) samples of the E5 composition were mixed, and placed into a series of flexible blow molded bottles, and each bottle was sealed with a gas-tight cap. Equal amounts of the E5 composition was supplied to each of the bottles (samples; replicates) to provide a consistent amount of available headspace in the bottles (approx. 10% by volume), prior to sealing. The bottles and caps used were identical, and the bottles had a nominal fluid volume of 32 fluid ounce. The bottles had two generally planar opposing sidewalls which were the point at which the thickness of the plastic was the least, thus making this part of the bottle most responsive to internal pressures and most resilient. At the midpoints of the exterior of the two generally planar opposing sidewalls of these bottles were placed a mark using a waterproof marker and each of the bottles was similarly marked with these two reference points. Thereafter a digital caliper could be used to measure the width of the bottle between these two reference points. The bottles containing the E5 compositions were measured after the initial filling at room temperature (20° C.) and the measurement was noted (Week 0). Thereafter, filled bottles containing the E5 composition were stored at one of the following temperatures: 25° C., 30° C., 40° C., and 50° C. over the span of several weeks. At the time intervals indicated on Table 5, each bottle was removed from the indicated storage temperature, allowed to equilibrate to room temperature (approx. 20° C.) for 24 hours, then measured utilizing the digital caliper, with the indicated results reported on the table and then subsequently returned to storage at the indicated temperature. As indicated on the following Table 5, the reading (in millimeters) at a particularly weekly interval was recorded and the % gain was representative of the degree of “bloating” of the bottle, which in part is believed to be attributable to the amount of gas evolved from the E5 composition and trapped within the sealed, flexible blow molded bottles.

TABLE 5

| | | caliper | | caliper | | caliper | |
|---|---|---|---|---|---|---|---|
| | Initial Caliper | reading | | reading | | reading | |
| | reading (mm) | (mm) | % loss/gain | (mm) | % loss/gain | (mm) | % loss/gain |
| | | Week 1 | Week 1 | Week 2 | Week 2 | Week 3 | Week 3 |
| 25° C./E5 (bottle 1) | 65.67 | 65.06 | −1 | 66.23 | +1 | 65.29 | −1 |
| 25° C./E5 (bottle 2) | 65.98 | 66.10 | 0 | 67.13 | +2 | 66.20 | 0 |
| 25° C./E5 (bottle 3) | 64.57 | 65.35 | 0 | 65.11 | +1 | 64.37 | 0 |
| 25° C./E5 (bottle 4) | 63.45 | 63.51 | 0 | 64.18 | +1 | 64.30 | +1 |
| 25° C./E5 (bottle 5) | 64.88 | 65.68 | +1 | 65.54 | +1 | 65.28 | +1 |
| 40° C./E5 (bottle 1) | 65.27 | 66.46 | +2 | 68.08 | +4 | 67.40 | +3 |
| 40° C./E5 (bottle 2) | 63.46 | 66.10 | +4 | 67.50 | +6 | 66.91 | +5 |
| 40° C./E5 (bottle 3) | 65.32 | 67.42 | +3 | 68.51 | +5 | 68.70 | +5 |
| 40° C./E5 (bottle 4) | 64.64 | 66.97 | +4 | 66.91 | +4 | 67.83 | +5 |
| 40° C./E5 (bottle 5) | 65.20 | 66.94 | +3 | 67.63 | +4 | 67.50 | +4 |
| 50° C./E5 (bottle 1) | 64.58 | 69.36 | +7 | 71.74 | +11 | 69.33 | +7 |
| 50° C./E5 (bottle 2) | 64.96 | 70.37 | +8 | 73.87 | +14 | 74.70 | +15 |
| 50° C./E5 (bottle 3) | 64.03 | 68.84 | +8 | 71.69 | +12 | 73.05 | +14 |
| 50° C./E5 (bottle 4) | 65.30 | 70.83 | +8 | 73.27 | +12 | 74.61 | +14 |
| 50° C./E5 (bottle 5) | 64.39 | 69.16 | +7 | 71.77 | +11 | 73.13 | +14 |
| | | Week 4 | Week 4 | Week 5 | Week 5 | Week 6 | Week 6 |
| 25° C./E5 (bottle 1) | 65.67 | 65.98 | 0 | 65.64 | 0 | 66.00 | +1 |
| 25° C./E5 (bottle 2) | 65.98 | 67.02 | +2 | 66.41 | +1 | 66.86 | +1 |
| 25° C./E5 (bottle 3) | 64.57 | 64.58 | 0 | 64.31 | 0 | 64.60 | 0 |
| 25° C./E5 (bottle 4) | 63.45 | 63.61 | 0 | 63.63 | 0 | 64.39 | +1 |
| 25° C./E5 (bottle 5) | 64.88 | 64.99 | 0 | 65.27 | +1 | 65.22 | +1 |
| 40° C./E5 (bottle 1) | 65.27 | 67.56 | +4 | 68.07 | +4 | 69.00 | +6 |
| 40° C./E5 (bottle 2) | 63.46 | 66.98 | +6 | 67.51 | +6 | 68.72 | +8 |
| 40° C./E5 (bottle 3) | 65.32 | 68.79 | +5 | 69.26 | +6 | 69.69 | +7 |
| 40° C./E5 (bottle 4) | 64.64 | 67.08 | +4 | 68.25 | +6 | 68.84 | +6 |
| 40° C./E5 (bottle 5) | 65.20 | 67.40 | +3 | 68.45 | +5 | 69.71 | +7 |
| 50° C./E5 (bottle 1) | 64.58 | 71.45 | +11 | 72.41 | +12 | 73.82 | +14 |
| 50° C./E5 (bottle 2) | 64.96 | 75.84 | +17 | 77.09 | +19 | 71.53 | +10 |
| 50° C./E5 (bottle 3) | 64.03 | 74.24 | +16 | 68.04 | +6 | 69.50 | +9 |
| 50° C./E5 (bottle 4) | 65.30 | 75.08 | +15 | 74.82 | +15 | 70.61 | +8 |
| 50° C./E5 (bottle 5) | 64.39 | 73.89 | +15 | 74.85 | +16 | 76.15 | +18 |
| | | Week 7 | Week 7 | Week 8 | Week 8 | Week 9 | Week 9 |
| 25° C./E5 (bottle 1) | 65.67 | 66.39 | +1 | 66.27 | +1 | 66.23 | +1 |
| 25° C./E5 (bottle 2) | 65.98 | 66.84 | +1 | 66.18 | 0 | 66.14 | 0 |
| 25° C./E5 (bottle 3) | 64.57 | 65.59 | +2 | 64.94 | +1 | 65.44 | +1 |
| 25° C./E5 (bottle 4) | 63.45 | 65.06 | +3 | 64.79 | +2 | 64.64 | +2 |
| 25° C./E5 (bottle 5) | 64.88 | 66.15 | +2 | 65.6 | +1 | 66.13 | +2 |
| 40° C./E5 (bottle 1) | 65.27 | 70.64 | +8 | 70.96 | +9 | 71.95 | +10 |
| 40° C./E5 (bottle 2) | 63.46 | 70.23 | +11 | 70.53 | +11 | 71.69 | +13 |
| 40° C./E5 (bottle 3) | 65.32 | 71.63 | +10 | 71.96 | +10 | 72.96 | +12 |
| 40° C./E5 (bottle 4) | 64.64 | 70.57 | +9 | 70.97 | +10 | 72.11 | +12 |
| 40° C./E5 (bottle 5) | 65.20 | 70.77 | +9 | 71.21 | +9 | 72.20 | +11 |
| 50° C./E5 (bottle 1) | 64.58 | 76.27 | +18 | 77.66 | +20 | 79.36 | +23 |
| 50° C./E5 (bottle 2) | 64.96 | 73.68 | +13 | 72.64 | +12 | 75.75 | +17 |
| 50° C./E5 (bottle 3) | 64.03 | 72.33 | +13 | 73.07 | +14 | 71.57 | +12 |
| 50° C./E5 (bottle 4) | 65.30 | 73.69 | +13 | 70.75 | +8 | 73.60 | +13 |
| 50° C./E5 (bottle 5) | 64.39 | 78.10 | +21 | 79.22 | +23 | 73.51 | +14 |
| | Initial Caliper | caliper | % | caliper | % | | |
| | reading (mm) | reading (mm) | loss/+2gain | reading (mm) | loss/gain | | |
| | | Week 10 | Week 10 | Week 11 | Week 11 | | |
| 25° C./E5 (bottle 1) | 65.67 | 67.20 | +2 | 67.09 | +2 | | |
| 25° C./E5 (bottle 2) | 65.98 | 66.74 | +1 | 66.86 | +1 | | |
| 25° C./E5 (bottle 3) | 64.57 | 66.17 | +2 | 65.85 | +2 | | |
| 25° C./E5 (bottle 4) | 63.45 | 65.42 | +3 | 65.04 | +3 | | |
| 25° C./E5 (bottle 5) | 64.88 | 66.89 | +3 | 66.54 | +3 | | |
| 40° C./E5 (bottle 1) | 65.27 | 73.19 | +12 | 73.30 | +12 | | |
| 40° C./E5 (bottle 2) | 63.46 | 72.71 | +15 | 72.97 | +15 | | |
| 40° C./E5 (bottle 3) | 65.32 | 73.82 | +13 | 73.95 | +13 | | |
| 40° C./E5 (bottle 4) | 64.64 | 73.16 | +13 | 72.96 | +13 | | |
| 40° C./E5 (bottle 5) | 65.20 | 73.03 | +12 | 73.35 | +13 | | |
| 50° C./E5 (bottle 1) | 64.58 | n.t. | n.t. | n.t. | n.t. | | |
| 50° C./E5 (bottle 2) | 64.96 | 75.35 | +16 | 74.39 | +15 | | |
| 50° C./E5 (bottle 3) | 64.03 | 68.55 | +7 | 68.39 | +7 | | |
| 50° C./E5 (bottle 4) | 65.30 | 72.59 | +11 | 71.99 | +10 | | |
| 50° C./E5 (bottle 5) | 64.39 | n.t. | n.t. | n.t. | n.t. | | |

n.t. = indicates that the bottle was not tested

As is evidenced from the forgoing the compositions of the invention exhibited satisfactory to superior storage characteristics as demonstrated by limited bloating of the storage bottles a the recited storage conditions.

### Evaluation of Antimicrobial Efficacy:

A sample of the composition of E1 as described on Table 1 above was evaluated in order to evaluate their antimicrobial efficacy against Staphylococcus aureus (gram positive type pathogenic bacteria) (ATCC 6538), and Salmonella enterica (ATCC 10708). The testing was performed in accordance with the protocols outlined in “Use-Dilution Method”, Protocols 955.14, 955.15 and 964.02 described in Chapter 6 of “Official Methods of Analysis”, 16^{th} Edition, of the Association of Official Analytical Chemists; “Germicidal and Detergent Sanitizing Action of Disinfectants”, 960.09 described in Chapter 6 of “Official Methods of Analysis”, 15^{th} Edition, of the Association of Official Analytical Chemists; or American Society for Testing and Materials (ASTM) E 1054-91 the contents of which are herein incorporated by reference. This test is also commonly referred to as the “AOAC Use-Dilution Test Method”. The E1 composition was tested without any further dilution. The test substrates were sterile stainless steel penicylinders as specified by the AOAC Use-Dilution Test Method. Testing was performed at ambient temperatures in the range of 19-21° C., viz., approximately room temperature (=20° C.).

As is appreciated by the skilled practitioner in the art, the results of the AOAC Use-Dilution Test Method indicates the number of test substrates wherein the tested organism remains viable after contact for 10 minutes with at test disinfecting composition/total number of tested substrates (cylinders) evaluated in accordance with the AOAC Use-Dilution Test. Thus, a result of “0/60” indicates that of 60 test substrates bearing the test organism and contacted for 10 minutes in a test disinfecting composition, 0 or 1 test substrates had viable (live) test organisms at the conclusion of the test. Such a result is excellent, illustrating the excellent disinfecting efficacy of the tested composition. reported results indicate the number of test cylinders with live test organisms/number of test cylinders tested for each example formulation and organism tested; in several instances plural tests for a test organism are reported when several tests against the same test organism was repeated. In both tests, the results were “0/60” for the two tested microorganisms.

As may be seen from the results indicated above, the compositions according to the invention provide excellent sanitizing benefits to hard surfaces as demonstrated by the excellent antimicrobial efficacy of these compositions against known bacteria commonly found in bathroom, kitchen and other environments.

The remaining example compositions “E” described on Table 1 are expected to provide similarly satisfactory antimicrobial efficacy.

### Cleaning Evaluations:

The compositions according to the invention, and especially compositions E1 and E4, provide good cleaning efficacy of one or more stains selected from rust stains, greasy soils, and limescale deposits or limescale stains.

### Limescale Dissolution Evaluation:

The efficacy the E1 composition of the invention in the removal of limescale was evaluated by the following test.

Several pre-weighed and dried marble cubes (measured in grams) were first prepared by rinsing them with copious amounts of deionized water and subsequently the rinsed marble cubes were placed into a 105° C. oven for at least one hour in order to fully dry. The marble cubes were then removed from the oven, and allowed to cool to room temperature (approx. 20° C.) and each was then individually weighed on an analytical balance. Thereafter, for each tested formulation tested, two marble cube was placed into separate a trays, and 8 ml of a test composition was placed on top of the cube and allowed to remain there for 5 minutes for the first cube, and 10 minutes for the second cube, after which the cubes were then individually rinsed with copious amounts of deionized water and again, after rinsing, each of the cubes was placed into a 105° C. oven for at least one hour in order to fully dry. Subsequently the cubes were allowed to cool to room temperature and reweighed.

The percentage loss of each of the cubes was calculated, and the results are reported on Table 5.

TABLE 5

| E1 | % limescale dissolved (% loss) |
|---|---|
| Cube 1 | 0.0186 |
| Cube 2 | 0.0160 |
| Cube 3 | 0.0192 |

As is evident from the foregoing results, the tested compositions provided a good degree of dissolution of the marble cubes tested.

### Rust Stain Cleaning Evaluation:

Compositions according to formula E4 according to the invention, as well as aliquots of deionized water, were evaluated for their efficacy in the removal of rust stains from hard surfaces generally in accordance with the following protocol. Each tested composition was tested on 9 separate tiles.

A standardized rust soil was prepared by combining 98% wt. deionized water at room temperature with 2% ferric chloride which was mixed until a uniform soil composition was formed. A separate 1% sodium hydroxide solution was also produced by combining 99% wt. deionized water at room temperature with 1% wt. NaOH pellets and mixing until a clear solution was formed.

Both the standardized rust soil and the sodium hydroxide solution were used within 24 hours of their production.

As substrates, a series of standard glazed white ceramic bathroom tiles were used. Each of the tiles was first washed in water and dried with a paper towel, after which the tiles were washed with isopropanol then placed into a vertical rack and dried at room temperature. The reflectance reading of a random tile was evaluated using a digital camera which read the reflection of the surface of the tile. The readings thus obtained were used as the reference value for a “clean tile” in later calculations concerning cleaning efficacy.

Next, the dried tiles were placed on a flat surface, and using a fine mist sprayer an even coating of the standardized rust soil was applied to an exposed surface of the plate. Subsequently the 1% NaOH aqueous solution was applied to the dried tile surfaces using a fine mist sprayer and again, thereafter the tile surfaces were allowed to dry on a laboratory bench for ½ to 1 hour. The foregoing application procedure was repeated two more times for each tile in order to build up three layer of the standardized rust soil on each tile. Thereafter the tiles were allowed to dry overnight at room temperature (20° C.-25° C.) to ensure that the coated tiles were fully dried. Next, the surface reflectance reading of the each of the prepared, soiled tiles was again evaluated as indicated above, using a digital camera which read the reflection of the surface of each of the tiles. The readings thus obtained used as the reference value for the “soiled tile” which was later treated with a sample composition or with the “control” composition, namely deionized water.

To evaluate rust removal efficacy, each tile was then placed in an individual bath of tap water (water from municipal supply source, Montvale, N.J.) to immerse the lower half of each tile. Each tile was inclined in each individual water bath. To the upper the non-immersed part of the soiled surface of each tile was pipetted 2 ml of each tested composition; the test composition was released, and although it initially contacted the “top”, non-immersed part of each tile, was allowed to run down the inclined surface of the tile and enter the tap water and thus form a diluted solution which was in contact with the “bottom”, immersed part of each tile. The treated tile was allowed to stand partially immersed for 10 minutes. Thereafter the plate was removed, laid on a flat surface, and each of the top and bottom parts were scrubbed with 10 strokes of short haired plastic bristle brush to provide a degree of manual loosening of the tile surface, and thereafter rinsed in a stream of cold tap water for 10 to 15 seconds. Thereafter each treated tile was allowed to dry overnight at room temperature (20° C.-25° C.) to ensure that they were fully dried. Thereafter the surface reflectance of the “top”, non-immersed part of each tile which corresponded to the cleaning efficacy of the non-diluted aliquot of the tested composition, and the surface reflectance of the “bottom”, immersed part of each tile which corresponded to the cleaning efficacy of the aqueous dilution of each treated tile was evaluated using a digital camera which read the reflection of the surface of each of the tiles. According to the reflective means, the percentage of rust removal was determined utilizing the following equation:

$$\% removal = \frac{RC - RS}{RO - RS} \times 100$$

where

RC=Reflectance of tile surface after cleaning with test product

RO=Reflectance of original cleaned tile surface

RS=Reflectance of soiled tile surface prior to treatment with test product.

The percent of rust stain cleaning efficacy using the diluted and undiluted E4 composition, as compared to deionized water (control) is reported on the following Table 6:

TABLE 6

| | % removal, top | % removal, bottom |
|---|---|---|
| E4 (tile 1) | 71.96 | 53.65 |
| E4 (tile 2) | 57.97 | 73.06 |
| E4 (tile 3) | 64.65 | 63.44 |
| E4 (tile 4) | 53.95 | 50.58 |
| E4 (tile 5) | 23.41 | 48.55 |
| E4 (tile 6) | 28.42 | 53.43 |
| E4 (tile 7) | 36.80 | 42.66 |
| E4 (tile 8) | 35.67 | 56.32 |
| E4 (tile 9) | 70.88 | 68.04 |
| water (tile 1) | 23.16 | 30.36 |
| water (tile 2) | 10.49 | 26.44 |
| water (tile 3) | 15.86 | 31.25 |
| water (tile 4) | 27.81 | 23.84 |
| water (tile 5) | 18.30 | 15.61 |
| water (tile 6) | 9.98 | 15.78 |
| water (tile 7) | 18.68 | 4.30 |
| water (tile 8) | 7.41 | 17.53 |
| water (tile 9) | 12.94 | 28.93 |

As can be seen from the results of the foregoing table, the compositions of the invention exhibited excellent cleaning of rust stains compared to the comparative compositions (water) tested, notwithstanding the absence of organic acids comprising less than three carboxylate (—COOH) moieties.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A largely aqueous hard surface treatment composition which comprises:
at least one or more peroxygen compounds,
a betaine surfactant,
an anionic surfactant,
a water soluble or water dispersible metal salt,
a chelating agent,
an inorganic acid constituent,
water,
optionally a pH adjusting agent,
and optionally one or more further constituents which provide a technical or aesthetic benefit to the inventive composition of which it forms a part, wherein the compositions exhibit a viscosity in the range of about 100-2000 cPs, when measured at room temperature and exhibit a pH in the range of about 2 to about 4, and further wherein the composition contain no organic acids comprising less than three carboxylate (—COOH) moieties, and that the inorganic acid constituent preferably comprises sulfonic acid.

2. A composition according to claim 1 wherein the at least one or more peroxygen compounds comprise hydrogen peroxide.

3. A composition according to claim 1 wherein the at least one or more peroxygen compounds consist of hydrogen peroxide.

4. A composition according to any preceding claim, wherein the betaine surfactant is cocoamidopropyl dimethyl betaine.

5. A composition according to any preceding claim, wherein the anionic surfactant is sodium lauryl ether sulfate.

6. A composition according to any preceding claim, having a pH of 2.5-3.5.

7. A composition according to any preceding claim, wherein the composition exhibits an antimicrobial benefit against gram-positive and/or gram-negative bacteria.

8. A composition according to any preceding claim, wherein the inorganic acid constituent comprises sulfonic acid.

9. A method of process for the cleaning treatment of hard surfaces having one or more stains selected from rust stains, limescale deposits or limescale stains, the process comprising the step of:
applying a cleaning effective amount of a composition according to any preceding claim to a hard surface in need of a cleaning treatment.
